(19) United States
(12) Patent Application Publication
(10) Pub. No.: US 2004/0013399 A1
(43) Pub. Date: Jan. 22, 2004

(54) Information processing method and apparatus

(76) Inventors: Masato Horiguchi, Tokyo (JP); Satoshi Mitsuhashi, Tokyo (JP)

Correspondence Address: FROMMER LAWRENCE & HAUG, 745 FIFTH AVENUE- 10TH FL., NEW YORK, NY, 10151, US

(21) Appl. No.: 10/262,091

(22) Filed: Oct. 1, 2002

(30) Foreign Application Priority Data
Oct. 2, 2001 (JP) 2001-306792

(51) Int. Cl. H04N 5/91; H04N 7/26

(52) U.S. Cl. 386/46; 348/111

(57) ABSTRACT

An information processing apparatus in which compressed picture information of different compression encoding formats may be generated and recorded on different recording mediums without enlarging the size of the apparatus. An MPEG2 encoder 2 is supplied with the picture information and encodes the input information in the MPEG 2 format under control by a CPU 3 to generate an MPEG 2. A hard disc drive 5 records the MPEG2 bitstream on the hard disc under control by the CPU 3. The CPU 3 boots a software on a memory to perform transcode processing to generate an MPEG 4 bitstream from the MPEG2 bitstream. The motion vector as found in transiently decoding the MPEG2 bitstream into the picture information is inherited and re-used as the motion vector for the MPEG 4 bitstream. A memory card drive 6 records the MPEG 4 bitstream on the memory card under control by the CPU 3.

### BACKGROUND OF THE INVENTION

1. Field of the Invention

This invention relates to an information processing method and an information processing apparatus and, more particularly, to an information processing method and an information processing apparatus capable of recording the compressed picture information of different formats in respective different recording mediums.

2. Description of Related Art

Recently, such an apparatus which handles the picture information as digital data and which compresses the picture information by orthogonal transform, such as discrete cosine transform and motion compensation, under the MPEG (Moving Picture Experts Group) system, by exploiting redundancy characteristic of the picture information, with a view to transmitting and storing the information with high efficiency, is finding widespread application in both information distribution by a broadcasting station and information reception by household receivers.

In particular, the MPEG 2 (ISO/IEC 13818-2) is defined as being a general-purpose encoding system and represents a standard system encompassing both interlaced scanned pictures and progressive scanned pictures and also encompassing both standard resolution pictures and high definition pictures, and hence the use of this system is predicted to be promising in both professional use and a wide field of consumer-oriented application. If, with the use of the MPEG 2 compression system, the code quantity (bit rate) of 18 to 22 Mbps is allocated, it is possible to realize a high compression ratio and a satisfactory picture quality with an interlaced scanned picture of standard resolution having 4 to 8 Mbps 720×480 pixels or with an interlaced scanned picture of high-definition resolution having 1920×1088 pixels.

The MPEG 2, mainly targeted at achieving a high picture quality encoding mainly consistent with broadcasting, has not been consistent with an encoding system having a code quantity (bit rate) lower than in MPEG 1, that is, an encoding system of a higher compression ratio. However, with coming into widespread use of portable terminals, the need for such encoding system is felt to be increasing in near future. The MPEG 4 encoding system has been standardized in keeping up with this predictable needs. The standard of the MPEG 4 picture encoding system has been accepted as international standard as ISO/IEC 14496-2 in December 1998.

Thus, the MPEG 2 is a compression system convenient for digital broadcast for HDTV (High Definition TeleVision), while the MPEG 4 is a compression system convenient for computer communication employing the wireless environment and a communication channel having a small capacity.

The conventional information processing apparatuses are provided with plural different codecs (COde/DECode), such as those for the MPEG 2 or MPEG 4, and are designed for preparing plural compressed files of the types conforming to the respective codecs responsive to the input picture information. This information processing apparatus records the compressed files of both the MEPG 2 and MPEG 4 forms, as formulated, on the same recording medium, such as hard disc.

Meanwhile, the aforementioned information processing apparatus includes motion vector detectors (ME) on both the MEPG 2 encoder for encoding to the MPEG 2 format and the MEPG 4 encoder for encoding to the MEPG 4 format. Since the motion vector detector is of such a size that it takes up not less than one half the size of the MEPG 2 encoder and the MEPG 4 encoder, thus increasing the overall size of the apparatus.

On the other hand, the information processing apparatus is designed for recording the compressed file of the MEPG 2 or MEPG 4 format on the same hard disc, such that it is not designed for permitting other equipment, such as a portable information terminal, to freely reproduce e.g., a compressed file of the MPEG 4 format.

### SUMMARY OF THE INVENTION

It is therefore an object of the present invention to provide a method and an apparatus for generating the compressed picture information of different compression coding systems and recording the so generated information on different recording mediums, without increasing the size of the apparatus.

In one aspect, the present invention provides an information processing apparatus for compression encoding the input picture information, as input, into the first compressed picture information by discrete cosine transform and motion compensation, and for converting the first compressed picture information into the second compressed picture information, the apparatus including first recording and/or reproduction controlling means for recording the first compressed picture information on a first recording medium and/or reproducing the recorded compressed picture information from the first recording medium, compressed picture information converting means for converting the first compressed picture information into the second compressed picture information using a parameter contained in the first compressed picture information, and second recording and/or reproduction controlling means for recording the second compressed picture information, as converted by the compressed picture information converting means, on a second recording medium, and/or reproducing the second compressed picture information, as recorded, from the second recording medium.

The compressed picture information converting means includes motion vector converting means for converting the first motion vector into a second motion vector for the second compressed picture information by inheriting a first motion vector as found in decoding the first compressed picture information by the first compressed picture information decoding means and by using a macro-block of the first compressed picture information. The first recording medium is a magnetic recording medium. The second recording medium is preferably a removable plate-shaped recording medium.

With this information processing apparatus, the motion vector contained in the first compressed picture information is inherited as the first compressed picture information is recorded on a magnetic recording medium, and the second compressed picture information is generated by a second motion vector as converted using a macro-block of the first compressed picture information. This second compressed picture information is recorded on the removable plate-shaped recording medium to enable the compressed picture information of different compression encoding systems to be recorded on different recording mediums.

Thus, the information processing apparatus is able to simultaneously record the different compressed picture information, such as the first and second compressed picture information, on different recording mediums, such as a magnetic recording medium and a plate-shaped recording medium. Since the plate-shaped recording medium is removable, the user is free to dismount the plate-shaped recording medium, having recorded the second compressed picture information thereon, and to use another equipment, such as a portable information terminal, as a second compressed picture information terminal, to view the second compressed picture information. This information processing apparatus is easy and convenient to use for the user since the processing of copying the second compressed picture information on the plate-shaped recording medium, as required when both the first and second compressed picture information have been recorded on the magnetic recording medium, can be omitted.

On the other hand, with the information processing apparatus in which the motion vector converting means of the compressed picture information converting means mainly inherits the first motion vector of the first compressed picture information for conversion to the second motion vector for the second compressed picture information, the compression encoding processing, in particular the motion vector compensation processing, on the second compressed picture information, can be relieved significantly.

With the present information processing apparatus, the motion vector contained in the first compressed picture information is inherited, the second compressed picture information is generated by the second motion vector as converted from the inherited motion vector using the macroblock of the first compressed picture information, and recorded on the removable plate shaped recording medium, thereby recording the compressed picture information of different compression encoding format on different recording mediums.

In another aspect, the present invention provides an information processing method for compression encoding the input picture information, as input, into the first compressed picture information by discrete cosine transform and motion compensation, and for converting the first compressed picture information into the second compressed picture information, in which the method includes a first recording controlling step of recording said first compressed picture information on a first recording medium, a compressed picture information converting step of converting said first compressed picture information into said second compressed picture information using a parameter contained in said first compressed picture information, and a second recording controlling step of recording said second compressed picture information, as converted by said compressed picture information converting step, on a second recording medium.

The compressed picture information converting step includes inheriting a first motion vector as found in decoding the first compressed picture information by the first compressed picture information decoding means and converting the first motion vector into a second motion vector for the second compressed picture information using a macro-block of the first compressed picture information. The first recording medium is a magnetic recording medium. The second recording medium is preferably a removable plate-shaped recording medium.

With this information processing method, the motion vector contained in the first compressed picture information is inherited as the first compressed picture information is recorded on a magnetic recording medium, and the second compressed picture information is generated by a second motion vector as converted from the inherited motion vector using a macro-block of the first compressed picture information. This second compressed picture information is recorded on the removable plate-shaped recording medium to enable the compressed picture information of different compression encoding systems to be recorded on different recording mediums.

Thus, the information processing apparatus is able to simultaneously record different compressed picture information, such as the first and second compressed picture information, on different recording mediums, such as a magnetic recording medium and a plate-shaped recording medium. Since the plate-shaped recording medium is removable, the user is free to dismount the plate-shaped recording medium, having recorded the second compressed picture information thereon, and to use another equipment, such as a portable information terminal, as a second compressed picture information terminal, to view the second compressed picture information. This information processing apparatus is easy and convenient to use for the user since the processing of copying the second compressed picture information on the plate-shaped recording medium, a required when both the first and second compressed picture information have been recorded on the magnetic recording medium can be omitted.

Moreover, in the motion vector converting step of the compressed picture information converting step of the information processing method, the first motion vector of mainly the first compressed picture information is inherited and converted into the second motion vector for the second compressed picture information, the processing for compression encoding of the second compressed picture information, in particular the processing for motion compensation, can be facilitated significantly.

### BRIEF DESCRIPTION OF THE DRAWINGS

FIG. 1 is a block diagram showing a schematic structure of an inner circuit of an information processing apparatus embodying the present invention.

FIG. 2 is a flowchart showing the processing operation by the information processing apparatus.

FIG. 3 is a block diagram showing a schematic structure of an MPEG transcoder operating as a functional block of a CPU forming the information processing apparatus.

FIG. 4 is a block diagram showing a schematic structure of an MEPG 2 decoder forming the MPEG transcoder unit.

FIG. 5 is a block diagram showing a schematic structure of an MPGG4 encoder unit forming the MPEG transcoder unit.

### DESCRIPTION OF THE PREFERRED EMBODIMENT

Referring to the drawings, a preferred embodiment of the present invention will be explained in detail. In the present embodiment, the present invention is applied to an information processing apparatus for compression encoding the input picture information to the compressed picture information of different MPEG (Moving Picture Experts Group) formats by discrete cosine transform and motion compensation.

The present information processing apparatus is such an information processing apparatus for compression encoding the input picture information by discrete cosine transform and motion compensation into an MPGE2 bitstream as the first compressed picture information, and for converting the MPGE2 bitstream into an MPEG 4 bitstream as the second compressed picture information. The present information processing apparatus at least includes a hard disc drive, as first recording and/or reproducing controlling means, for recording and/or reproducing the MPGE2 bitstream on the bard disc as a first recording medium, an MPEG transcoder unit, as compressed picture information converting means, for converting the MPGE2 bitstream into the MEPG 4 bitstream, using parameters contained in the MPGE2 bitstream, and a memory card drive, as second recording and/or reproducing controlling means, for recording and/or reproducing the MEPG 4 bitstream, converted by the MPEG transcoder unit, on or from a memory card as second recording medium.

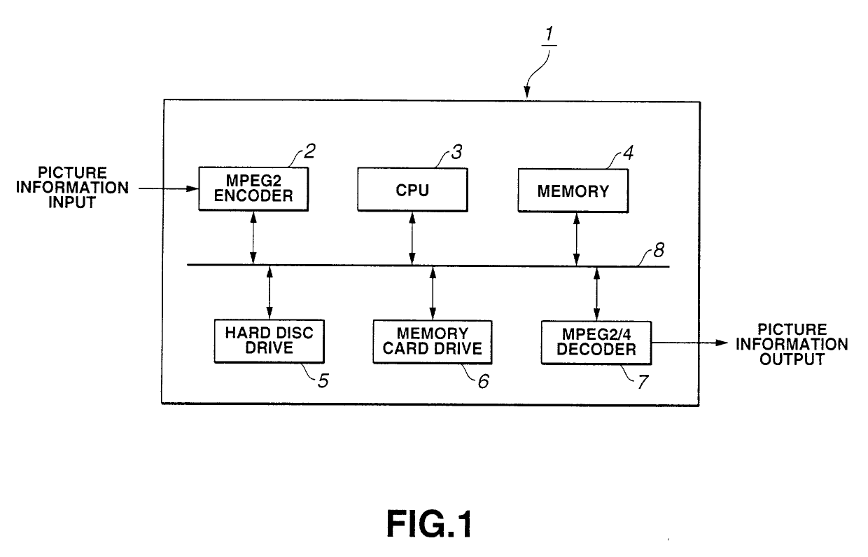

Referring to FIG. 1, the schematic structure of the information processing apparatus 1 is explained. The information processing apparatus 1 at least includes an MEPG 2 encoder 2 for compression encoding the input picture information into an MEPG 2 bitstream, a CPU (central processing unit) 3 for compression encoding the MEPG 2 bitstream by transcode software, referred to below simply as software, into an MEPG 4 bitstream, a memory 4, as a working area for the CPU 3, a hard disc drive 5, accommodating a hard disc, and adapted for recording and/or reproducing the information for the hard disc, a memory card drive 6 on which is loaded a removable thin plate shaped memory card, which is adapted for recording and/or reproducing the information for the memory card and an MPEG 2/4 decoder 7 for decoding the MPG2 bitstream and/or the MEPG 4 bitstream for restoring the picture information. The aforementioned components are interconnected to an inner bus 8.

The MEPG 2 encoder 2 is of a hardware structure and compression-encodes the input picture information to generate an MEPG 2 bitstream.

The CPU 3 controls the various parts to convert the MEPG 2 bitstream, output from the MEPG 2 encoder 2 over bus 8, into the MEPG 4 bitstream by the software booted on the memory 4. The CPU 3 inherits (re-uses) the motion vector, as found in transiently decoding the MEPG 2 bitstream into the picture information, as a motion vector of the MEPG 4 bitstream.

The hard disc drive 5 records and/or reproduces the MEPG 2 bitstream as a file on or from a hard disc accommodated therein. The memory card drive 6 records and/or reproduces the MEPG 4 bitstream as a file on or from the memory card loaded thereon.

The MPGG2/4 decoder 7 is of a hardware structure and decodes the bitstream of the MEPG 2 compressed file, recorded on the bard disc accommodated in the hard disc drive 5 and/or the bitstream of the MEPG 4 compressed file, recorded in the memory card, as loaded on the memory card drive 6, to decode the picture information.

The information processing apparatus 1, constructed as described above, generates the MEPG 2 bitstream, from the input picture information, and records the so generated MEPG 2 bitstream on the hard disc accommodated in the hard disc drive 5, at the same time as the information processing apparatus 1 converts the MPEG 2 bitstream by the software into the MEPG 4 bitstream for recording on the memory card loaded on the memory card drive 6.

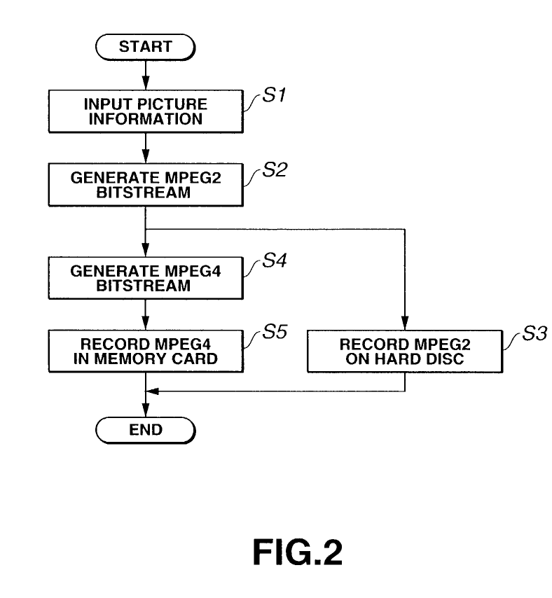

The processing operation by the information processing apparatus 1 is now explained by referring to the flowchart of FIG. 2. First, at step S1, the MEPG 2 encoder 2 inputs the picture information. At step S2, the MEPG 2 encoder 2 performs MPEG 2 style encoding processing on the input picture information, under control by the CPU 3, to generate the MEPG 2 bitstream.

At step S3, the hard disc drive 5 records the MEPG 2 bitstream from the MPEG 2 encoder 2 on the hard disc under control by the CPU 3.

At step S4, the CPU 3 boots the software on the memory 4 to perform transcode processing on the MEPG 2 bitstream supplied from the MEPG 2 encoder 2 to generate the MEPG 4 bitstream. At this time, the CPU 3 inherits (re-uses) the motion vector, as found in transiently decoding the MEPG 2 bitstream into the picture information, for use as the motion vector of the MEPG 4 bitstream.

At step S5, the memory card drive 6 records the MEPG 4 bitstream on the memory card, under control by the CPU 3.

In this manner, the information processing apparatus simultaneously records the compressed files of different formats, for example, the MEPG 2 and MPEG 4, on the hard disc and on the memory card, respectively. It is noted that, since the compressed MEPG 4 file prepared is of the capacity of approximately 5% of that of the compressed MEPG 2 file, the recording capacity of the hard disc remains unaffected even if the compressed MEPG 4 file is recorded on the hard disc.

The information processing apparatus is also able to decode the compressed MEPG 2 file recorded on the hard disc and/or the compressed MEPG 4 file recorded on the memory card to decode and output the picture information.

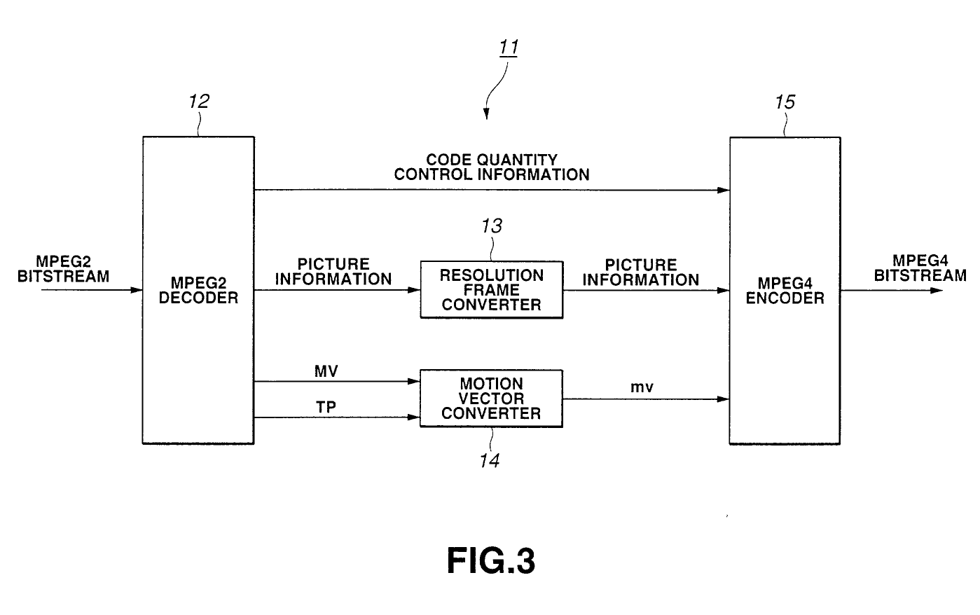

The CPU 3 may be deemed to have an MPEG transcoder, adapted to convert the MEPG 2 bitstream into the MEPG 4 bitstream by the software read into the memory 4, as a functional block. The schematic structure of this MPEG transcoder 11 is now explained with reference to FIG. 3.

The MPEG transcoder 11, operating as a functional block of the CPU 3, includes an MPEG decoder 12, a resolution frame rate conversion unit 13, a motion vector conversion unit 14 and an MEPG 4 encoder 15.

The MPEG decoder 12 decodes the MEPG 2 bitstream from the MPEG 2 encoder 2 (FIG. 1) to restore the picture information. At this time, the MPEG decoder 12 sends the restored picture information to the resolution frame rate conversion unit 13, while supplying the motion vector MV and the macro-block type, as found at the time of decoding, to the motion vector conversion unit 14, and supplying the code quantity controlling information (Pic-type difficulty), that is the information indicating a measure of complexity of the picture information, as required for code quantity control as later explained, to the MEPG 4 encoder 15.

The resolution frame rate conversion unit 13 converts the frame rate and the resolution of the picture information, for conversion to the MEPG 4 bitstream, to route the so converted frame rate and resolution to the MEPG 4 encoder 15. That is, the resolution frame rate conversion unit 13 halves the resolution in the vertical and horizontal directions of the picture information. If it is desired to realize a lower bit rate, the resolution frame rate conversion extracts, of the intra-frame coded picture (I-picture), forward prediction-coded picture (P-picture) and the bidirectional prediction-coded picture (B-picture), only the I-picture and the B-picture, and compresses the so extracted pictures in the time domain, in addition to compression by resolution conversion. If the input MEPG 2 bitstream is consistent with the NTSC (National Television System Committee) standard, that is an interlaced picture of 30 Hz with 720×480 pixels, the resolution after conversion in the resolution frame rate conversion unit 10 is 360×240 pixels. However, if, in encoding to the subsequent MPEG 4 bitstream, macro-block-based processing is to be performed, the number of pixels in the horizontal direction and that in the vertical direction need to be multiples of 16. The pixel replenishing or discarding for this purpose is performed simultaneously in the resolution frame rate conversion unit. That is, by way of the pixel replenishing or discarding, eight pixels on right or left side end in the horizontal direction are replenished or discarded to give 352×240 pixels.

The motion vector conversion unit 14 converts the MEPG 2 motion vector MV and the macro-block type TP from the MPEG decoder 12 into the motion vector mv corresponding to the motion vector of the macro-block following resolution conversion to send the so-converted motion vector to the MEPG 4 encoder 15.

Using the code quantity controlling information from the MPEG decoder 12 and the motion vector mv from the motion vector conversion unit 14, the MEPG 4 encoder 15 compression-encodes the picture information from the resolution frame rate conversion unit 13 into the MEPG 4 bitstream.

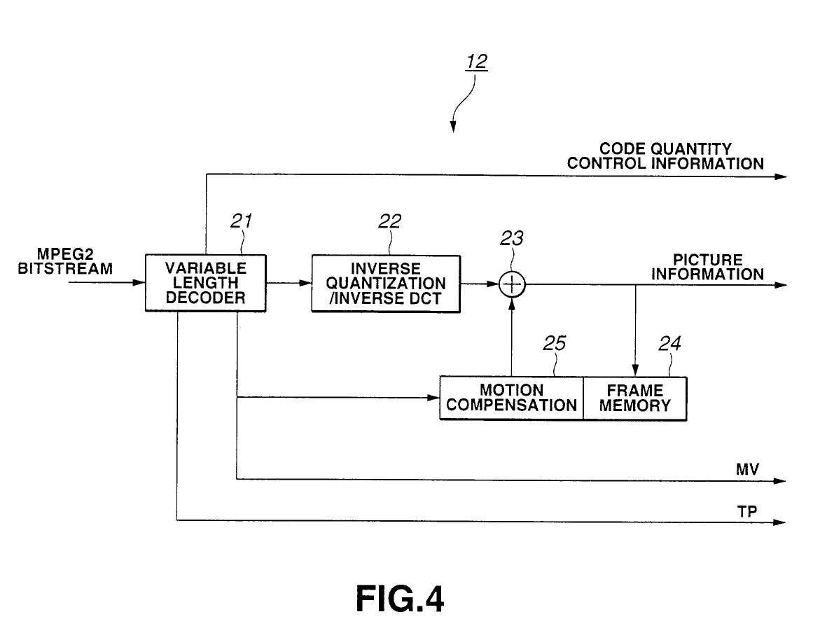

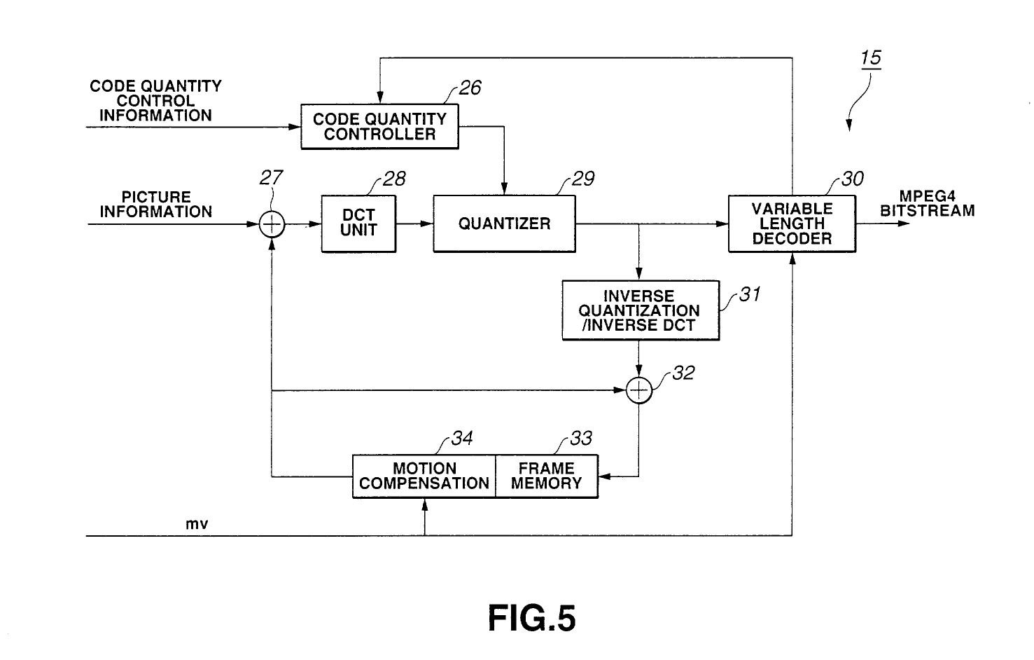

The MPEG decoder 12 and the MEPG 4 encoder 15 are explained in more detail by referring to FIGS. 4 and 5. The MPEG decoder 12 shown in FIG. 4 includes a variable length decoding unit 21, an inverse quantization/inverse DCT (discrete cosine transform) unit 22, an adder 23, a frame memory 24 and a motion compensation unit 25.

The variable length decoding unit 21 extracts the coding quantity controlling information and the macro-block type TP, from the input MEPG 2 bitstream, and routes the coding quantity controlling information to a coding quantity controller 26 as later explained while routing the macro-block type TP to the motion vector conversion unit 14 (FIG. 3). The variable length decoding unit 21 variable-length encodes the MEPG 2 bitstream and routes the quantized DCT coefficients to the inverse quantization/inverse DCT unit 22, while routing the motion vector MV to the mg; unit 25 and to the motion vector conversion unit 14 (FIG. 3).

The inverse quantization/inverse DCT unit 22 inverse-quantizes the quantized DCT coefficients and inverse discrete cosine transforms the resulting DCT coefficients to send the resulting signals to the adder 23.

The adder 23 is supplied not only with output data from the inverse quantization/inverse DCT unit 22 but also with output data from the motion compensation unit 25. That is, the motion compensation unit 25 reads out the picture information, already decoded and stored in the frame memory 24, based on the motion vector MV from the variable length decoding unit 21, and transmits the so read out information to the adder 23 as the picture prediction information. The adder 23 adds output data from the inverse quantization/inverse DCT unit 22 to the picture prediction information from the motion compensation unit 25 to decode the original picture information to send the resulting information to the resolution frame rate conversion unit 13 (FIG. 3).

The MEPG 4 encoder 15, shown in FIG. 5, includes a coding quantity controller 26, an adder 27, a DCT unit 28, a quantizer 29, a variable length encoder 30, an inverse quantization/inverse DCT unit 31, an adder 32, a frame memory 33 and a motion compensation unit 34.

The coding quantity controller 26 controls e.g., the quantization step in the quantizer 29, based on the code quantity controlling information supplied from the variable length decoding unit 21 (FIG. 4) and on the feedback information supplied from the variable length encoder 30.

The adder 27 calculates the difference between the picture information, the resolution and the frame rate of which have been converted by the resolution frame rate conversion unit 13 (FIG. 3), and the picture prediction information from the motion compensation unit 34, to send the resulting difference value to the DCT unit 28.

The DCT unit 28 processes output data from the adder 27 with DCT to route the resulting DCT coefficients to the quantizer 29.

The quantizer 29 quantizes the DCT coefficients with the quantization step supplied from the coding quantity controller 26, and routes the quantized DCT coefficients, along with the quantization steps, to the variable length encoder 30 and to the inverse quantization/inverse DCT unit 31.

The variable length encoder 30 variable-length-encodes the quantized DCT coefficients to output the resulting encoded coefficients as the MEPG 4 bitstream. The variable length encoder 30 also variable-length-encodes the quantization step from the quantizer 29 and the motion vector mv converted by the motion vector conversion unit 14 (FIG. 3) into a motion vector usable for MPEG 4. The variable length encoder 30 also feeds back the encoded frame-based bit quantity or the like information to the coding quantity controller 26.

The inverse quantization/inverse DCT unit 31 inverse-quantizes the quantized DCT coefficients, in accordance with the quantization step supplied from the quantizer 29, and sends the resulting DCT coefficients to the adder 32.

The adder 32 sums output data from the inverse quantization/inverse DCT unit 31 to the prediction picture information from the motion compensation unit 34 to locally decode the original picture information. This locally decoded picture information is supplied to and stored in the frame memory 33 so as to be used as the picture prediction information.

The information processing apparatus 1, constructed as described above, compression-encodes the input picture information into an MEPG 2 bitstream, and records the so generated MPEG 2 bitstream on the hard disc accommodated in the bard disc drive 5, as the MEPG 2 compressed file, at the same time as the information processing apparatus 1 converts the MEPG 2 bitstream into the MEPG 4 bitstream for recording as the MEPG 4 compressed file on the memory card loaded on the memory card drive 6. Since the memory card can be dismounted from the memory card drive 6, the user is able to dismount the memory card, having recorded the compressed MEPG 4 file, from the memory card drive 6, to view the MEPG 4 compressed file by exploiting another equipment, such as a portable information terminal, for example, a PDA (Personal Digital Assistant). It is noted that the information processing apparatus 1 is able to omit the processing of copying the compressed MEPG 4 file to the memory card, such as is required when both the compressed MEPG 2 file and the MEPG 4 compressed file have been recorded on the hard disc, thus improving the ease in handing the apparatus by the user.

On the other hand, with the information processing apparatus 1, since the input picture information has been compression-coded by the MEPG 2 encoder 2 of the hardware structure into the MEPG 2 bitstream, it is possible to relieve the load otherwise imposed on the CPU 3.

Moreover, with the information processing apparatus 1, the MEPG 2 bitstream is transiently decoded into the picture information by the MPEG transcoder 11, as a functional block of the CPU 3 by software booting, this picture information being then encoded into the MEPG 4 bitstream. Since the MPEG transcoder 11 at this time converts the motion vector MV, obtained on decoding the MEPG 2 bitstream, into the motion vector mv for the MEPG 4 bitstream, by simplified operating processing, the encoding processing into the MEPG 4 bitstream, in particular the motion compensation processing, can be simplified appreciably. Thus, with the information processing apparatus 1, it is possible to relieve the load otherwise imposed on the CPU 3.

Additionally, with the information processing apparatus 1, since the conversion from the MEPG 2 bitstream to the MEPG 4 bitstream is achieved by the software, as described above, there is no necessity for providing separate hardware, thus contributing to cost reduction.

The present invention is not limited to the above-described embodiment and hence can be modified without departing from its scope.

For example, although the above-described embodiment of the information processing apparatus processes the compressed picture information in accordance with the MEPG 2 and MEPG 4 formats, it is also possible to adapted the information processing apparatus for use with other compression encoding systems, such as MPEG 1 or with compression encoding systems different from the MPEG system.

Moreover, although the above-described embodiment of the information processing apparatus realizes the simultaneous generation of the MEPG 2 compressed file and the MEPG 4 compressed file with use of the hardware and the software, it is possible to realize such simultaneous generation with use only of the hardware.

What is claimed is:

1. An information processing apparatus for compression encoding the input picture information, as input, into the first compressed picture information by discrete cosine transform and motion compensation, and for converting the first compressed picture information into the second compressed picture information, said apparatus comprising:
first recording and/or reproduction controlling means for recording said first compressed picture information on a first recording medium and/or reproducing the recorded compressed picture information from said first recording medium;
compressed picture information converting means for converting said first compressed picture information into said second compressed picture information using a parameter contained in said first compressed picture information; and
second recording and/or reproduction controlling means for recording said second compressed picture information, as converted by said compressed picture information converting means, on a second recording medium, and/or reproducing the second compressed picture information, as recorded, from said second recording medium.

2. The information processing apparatus according to claim 1 wherein said compressed picture information converting means includes
first compressed picture information decoding means for decoding said first compressed picture information;
resolution frame rate converting means for converting the resolution and the frame rate of the picture information, decoded by said first compressed picture information decoding means, into the resolution and the frame rate of the picture information for said second compressed picture information;
motion vector converting means for converting said first motion vector into a second motion vector for said second compressed picture information by inheriting a first motion vector as found in decoding said first compressed picture information by said first compressed picture information decoding means and by using a macro-block of said first compressed picture information;
picture information encoding means for compression encoding the picture information, the resolution and the frame rate of which have been converted by said resolution frame rate converting means, into said second compressed picture information, by discrete cosine transform and motion compensation, using the second motion vector as converted by said motion vector converting means.

3. The information processing apparatus according to claim 1 wherein said first recording medium is a magnetic recording medium and wherein said second recording medium is a removable plate-shaped recording medium.

4. The information processing apparatus according to claim 1 further comprising:
recorded compressed picture information decoding means for decoding the first compressed picture information recorded on said first recording medium and/or the second compressed picture information recorded on said second recording medium.

5. The information processing apparatus according to claim 1 wherein the compression format of said first compressed picture information and said second compressed picture information conforms to different MPEG (Moving Picture Experts Group) formats.

6. The information processing apparatus according to claim 5 wherein the first compressed picture information and the second compressed picture information conform to the MEPG 2 and MEPG 4 formats, respectively.

7. An information processing method for compression encoding the input picture information, as input, into the first compressed picture information by discrete cosine transform and motion compensation, and for converting the first compressed picture information into the second compressed picture information, said method comprising:
a first recording controlling step of recording said first compressed picture information on a first recording medium;
a compressed picture information converting step of converting said first compressed picture information into said second compressed picture information using a parameter contained in said first compressed picture information; and
a second recording controlling step of recording said second compressed picture information, as converted by said compressed picture information converting step, on a second recording medium.

8. The information processing method according to claim 7 wherein said compressed picture information converting step includes
a first compressed picture information decoding step of decoding said first compressed picture information;
a resolution frame rate converting step of converting the resolution and the frame rate of the picture information decoded by said first compressed picture information decoding step into the resolution and the frame rate of the picture information for said second compressed picture information;
a motion vector converting step of inheriting a first motion vector as found in decoding said first compressed picture information by said first compressed picture information decoding step and for converting said first motion vector into a second motion vector for said second compressed picture information using a macro-block of said first compressed picture information; and
a picture information encoding step of compression encoding the picture information, the resolution and the frame rate of which have been converted by said resolution frame rate converting step, into said second compressed picture information, by discrete cosine transform and motion compensation, using the second motion vector as converted by said motion vector converting step.

9. The information processing method according to claim 7 wherein said first recording medium is a magnetic recording medium and wherein said second recording medium is a removable plate-shaped recording medium.

10. The information processing method according to claim 7 further comprising:
recorded compressed picture information decoding step of decoding the first compressed picture information recorded on said first recording medium and/or the second compressed picture information recorded on said second recording medium.

11. The information processing method according to claim 7 wherein the compression form of said first compressed picture information and said second compressed picture information conforms to different MPEG (Moving Picture Experts Group) formats.

12. The information processing method according to claim 7 wherein the first compressed picture information and the second compressed picture information conform to the MEPG 2 and MEPG 4 formats, respectively.
